(19) United States
(12) Patent Application Publication
(10) Pub. No.: US 2025/0167707 A1
(43) Pub. Date: May 22, 2025

(54) MOTOR DRIVE, MOTOR SYSTEM, AND METHOD FOR DRIVING MOTOR

(71) Applicant: KABUSHIKI KAISHA TOYOTA JIDOSHOKKI, Aichi-ken (JP)

(72) Inventor: Masanori TSUZAKA, Aichi-ken (JP)

(73) Assignee: KABUSHIKI KAISHA TOYOTA JIDOSHOKKI, Aichi-ken (JP)

(21) Appl. No.: 18/952,445

(22) Filed: Nov. 19, 2024

(30) Foreign Application Priority Data
Nov. 22, 2023 (JP) 2023-198073

(51) Int. Cl. H02P 21/34

(52) U.S. Cl. CPC H02P 21/34; H02P 2207/05

(57) ABSTRACT

A motor drive includes a power converter and a controller. The power converter drives a motor which includes a rotor having a permanent magnet and a stator having a coil wound around the stator. The controller performs a sensorless control of the motor using the power converter. The controller creates an angle difference between a d axis and a γ axis to accelerate the rotor to start the motor, and controls a power converter so that, during acceleration of the rotor, a d-axis current remains within a certain range, an angular velocity of the rotor monotonically increases, and the angle difference is kept within a given range not including zero.

### CROSS REFERENCE TO RELATED APPLICATIONS

This nonprovisional application is based on Japanese Patent Application No. 2023-198073 filed on Nov. 22, 2023 with the Japan Patent Office, the entire content of which is hereby incorporated by reference.

### BACKGROUND

The present disclosure relates to a motor drive, a motor system, and a method for driving a motor.

### DESCRIPTION OF THE BACKGROUND ART

During a sensorless control in which a motor is driven, without the use of a location sensor for detecting the location of a rotor, the motor can lose steps (synchronism). The motor losing steps may cause excessive torque fluctuations or may cause the motor to stop, failing to start successfully. Japanese Patent Laying-Open No. 2011-131725 discloses the electric power steering device that detects the motor losing steps during a sensorless control.

### SUMMARY

Depending on the application or conditions of a motor, there is a need to promptly start and/or stop the motor in the motor drive performing the sensorless control. To meet the need, the angular acceleration of the rotor (variations of the angular velocity of the rotor per unit time) is required to be increased. On the other hand, when the rotor has a higher angular acceleration, the motor is more likely to lose steps, as compared to a rotor having a lower angular acceleration.

The present disclosure is made to solve the above problem, and an object of the present disclosure is to allow the motor to promptly start, while the motor is being prevented from losing steps. Another object of the present disclosure is to allow the motor to promptly stop, while the motor is being prevented from losing steps.

(1) A motor drive according to a certain aspect of the present disclosure includes a power converter and a controller. The power converter drives a motor which includes a rotor having a permanent magnet and a stator having a coil wound around the stator. The controller performs a sensorless control of the motor using the power converter. The controller creates an angle difference, between a d axis in a d-q rotating frame and a γ axis estimating the d axis, to accelerate the rotor to start the motor. The controller controls the power converter so that, during acceleration of the rotor, a d-axis current remains within a certain range, an angular velocity of the rotor monotonically increases, and the angle difference is kept within a given range not including zero.

With the configuration (1) above, the angle difference is kept within the given range, that is, the angle difference is stabilized. This makes the motor unlikely to lose steps. Accordingly, the angular acceleration can be set to a higher value, thereby reducing the time taken for the motor to start. Thus, according to the configuration (1) above, the motor is allowed to start promptly, while being prevented from losing steps.

(2) A motor drive according to another aspect of the present disclosure includes a power converter and a controller. The power converter drives a motor which includes a rotor having a permanent magnet and a stator having a coil wound around the stator. The controller performs a sensorless control of the motor using the power converter. The controller creates an angle difference, between a d axis in a d-q rotating frame and a γ axis estimating the d axis, to decelerate the rotor to stop the motor. The controller controls the power converter so that, during deceleration of the rotor, a d-axis current remains within a certain range, an angular velocity of the rotor monotonically decreases, and the angle difference is kept within a given range not including zero.

With the configuration (2) above, the angle difference is kept within the given range, that is, the angle difference is stabilized. This makes the motor unlikely to lose steps. Accordingly, the angular acceleration can be set to a higher value, thereby reducing the time taken for the motor to stop. Thus, according to the configuration (2) above, the motor is allowed to stop promptly, while being prevented from losing steps.

(3) In a method for driving a motor according to still another aspect of the present disclosure, the motor includes a rotor having a permanent magnet and a stator having a coil wound around the stator. The method includes creating an angle difference, between a d axis in a d-q rotating frame and a 7 axis estimating the d axis, to accelerate the rotor to start the motor. Starting the motor includes causing a d-axis current to remain within a certain range, causing an angular velocity of the rotor to monotonically increase, and keeping the angle difference within a given range not including zero.

According to the method of (3) above, the motor is allowed to start promptly, while being prevented from losing steps, as with the configuration of (1) above.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a diagram showing an overall configuration of a motor system according to an embodiment of the present disclosure.

FIG. 2 is a diagram illustrating one example of a configuration of the motor system.

FIG. 3 is a diagram for illustrating a relationship between the coordinate axis and the magnetic pole location of a rotor during the start of a motor.

FIG. 4 is a time diagram illustrating changes over time in respective parameters upon start-up of a motor according to Comparative Example.

FIG. 5 is a time diagram illustrating changes over time in respective parameters upon start-up of a motor according to Embodiment 1.

FIG. 6 is a functional block diagram of a controller according to Embodiment 1.

FIG. 7 is a diagram for illustrating a relationship between the coordinate axis and the magnetic pole location of the rotor during a standstill of the motor.

FIG. 8 is a schematic diagram for illustrating angle differences during the start of the motor and during a standstill of the motor.

FIG. 9 is a time diagram illustrating changes over time in respective parameters upon cessation of the motor.

FIG. 10 is a schematic diagram for illustrating execution conditions for controls according to Embodiment 2.

FIG. 11 is a time diagram for illustrating an angle-difference correction control.

FIG. 12 is a diagram for illustrating an amount of angular acceleration correction in an angular acceleration correction control.

FIG. 13 is a functional block diagram of a controller according to Embodiment 2.

FIG. 14 is a flowchart illustrating a procedure for the angle-difference correction control.

FIG. 15 is a flowchart illustrating a procedure for a motor deterioration sensing.

FIG. 16 is a flowchart illustrating a procedure for the angular acceleration correction control.

### DESCRIPTION OF THE PREFERRED EMBODIMENTS

Hereinafter, embodiments according to the present disclosure will be described, with reference to the accompanying drawings. Note that like reference signs are used to refer to like or corresponding parts in the drawings, and the description thereof will not be repeated.

### Embodiment 1

### <System Configuration>

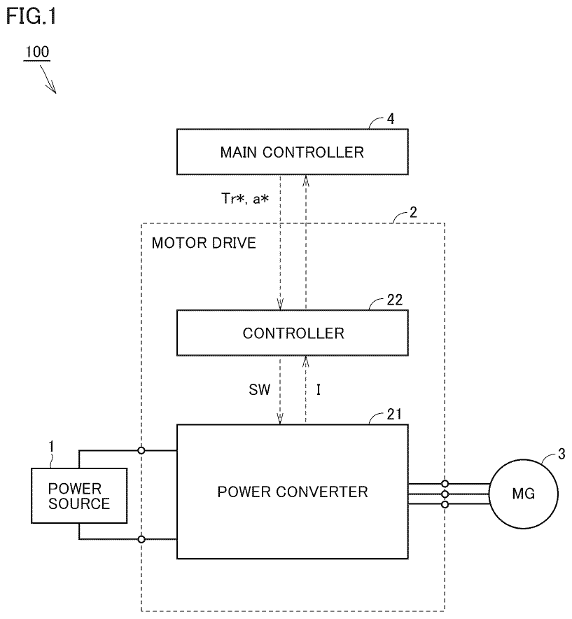

FIG. 1 is a diagram showing an overall configuration of a motor system according to an embodiment of the present disclosure. A motor system 100 is mounted on an electric-powered vehicle, for example. However, the application of the motor system 100 is not limited to vehicles. The motor system 100 may be used for a stationary system (e.g., an air conditioning system). The motor system 100 includes a power source 1, a motor drive 2, a motor 3, and a main controller 4.

The power source 1 supplies power to the motor drive 2. The power source 1 is, for example, a direct-current (DC) power supply (a DC system) such as a storage battery or a solar cell. The power source 1 may be an alternating-current (AC) power supply (an AC system).

The motor drive 2 drives the motor 3. The motor drive 2 includes: a power converter 21 for performing a power conversion operation on the power supplied from the power source 1; and a controller 22 for controlling the power converter 21 according to control commands from the main controller 4. The control commands from the main controller 4 to the controller 22 include a torque command Tr* and an angular acceleration command (a command for angular acceleration of the motor 3) a*.

The motor 3 is, typically, a three-phase AC rotating electric machine. The motor 3 is not provided with a location sensor (a resolver) for detecting the location of a rotor. Accordingly, the motor drive 2 performs a sensorless control of the motor 3.

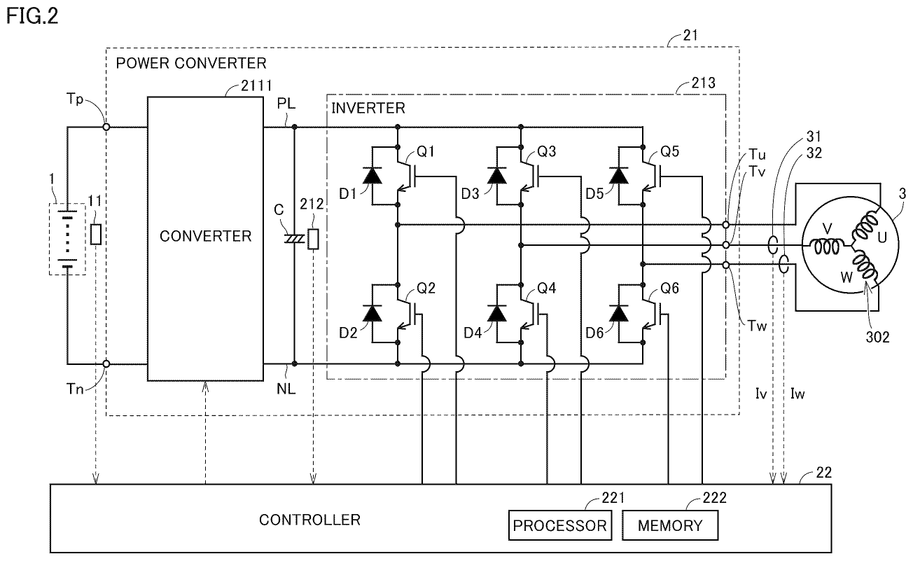

FIG. 2 is a diagram illustrating one example of a configuration of the motor system 100. However, FIG. 2 does not show the main controller 4 (see FIG. 1).

The power source 1, in this example, is a storage battery. The power source 1 outputs DC power to the power converter 21 via DC terminals Tp and Tn of the power converter 21. The power source 1 is provided with a monitoring unit (including a voltage sensor, a current sensor, etc.) 11 for monitoring the state of the power source 1. The monitoring unit 11 outputs the monitored voltage, current, etc., to the controller 22.

The power converter 21 converts the DC power from the power source 1 into AC power, according to the control commands from the controller 22, and outputs the AC power to the motor 3. More specifically, the power converter 21 includes, for example, a converter 211, a voltage sensor 212, and an inverter 213.

The converter 211 is, for example, a chopper converter, which includes one or more switching elements (not shown). The converter 211 steps up the voltage of the DC power from the power source 1 according to the control commands from the controller 22, and outputs the stepped-up DC power between a power line PL and a power line NL.

The voltage sensor 212 detects and outputs the voltage between the power lines PL and NL to the controller 22.

The inverter 213 is, for example, a two-level three-phase full-bridge circuit. The inverter 213 converts the DC power between the power lines PL and NL into AC power according to the control commands from the controller 22, and outputs the AC power to AC terminals Tu, Tv, and Tw. In this example, the inverter 213 includes six switching elements Q1, Q2, Q3, Q4, Q5, and Q6 and six freewheel diodes D1, D2, D3, D4, D5, and D6. The respective switching elements Q1 to Q6 are metal-oxide-semiconductor field-effect transistors (MOSFETs), insulated gate bipolar transistors (IGBTs), bipolar transistors, etc. The freewheel diodes D1 to D6 are connected in anti-parallel to the switching elements Q1 to Q6, respectively. The switching elements Q1 and Q2 are connected in series, forming a U-phase arm of the full-bridge circuit. The switching elements Q3 and Q4 are connected in series, forming a V-phase arm of the full-bridge circuit. The switching elements Q5 and Q6 are connected in series, forming a W-phase arm of the full-bridge circuit. The U-phase arm, the V-phase arm, and the W-phase arm are connected to the AC terminals Tu, Tv, and Tw, respectively. Each phase arm is connected between the power lines PL and NL.

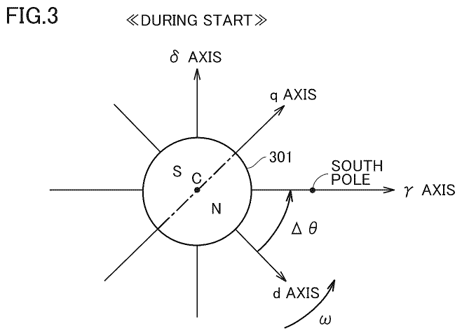

The motor 3 is a permanent magnet synchronous motor, and includes a rotor 301 (see FIG. 3) having a permanent magnet, and a stator 302 having coils wound around it. In this example, the stator 302 has a U-phase coil, a V-phase coil, and a W-phase coil. The coils have one ends star-connected to a neutral, and the other ends connected to points of connection to the switching elements of the respective phase arms of the inverter 213.

The motor 3 includes current sensors 31 and 32. The current sensor 31 detects a V-phase current Iv flowing through the motor 3. The current sensor 32 detects a W-phase current Iw flowing through the motor 3. Each current sensor outputs the detected current to the controller 22.

The controller 22 controls the converter 211 and the inverter 213, based on the torque command Tr* and the angular acceleration command a* from the main controller 4, and results of the detection by the various sensors (the monitoring unit 11, the voltage sensor 212, the current sensors 31 and 32, etc.). For example, the controller 22 outputs switching signals to the one or more switching elements included in the converter 211, and outputs switching signals SW to the six switching elements Q1 to Q6 included in the inverter 213. The switching signal SW is, typically, a PWM (pulse width modulation) signal.

The controller 22 includes the processor 221 and the memory 222 as the primary components. The processor 221 includes processing circuits (processing circuitry) such as a central processing unit (CPU), a micro processing unit (MPU), etc. The memory 222 includes volatile storage devices such as a dynamic random access memory (DRAM), a static random access memory (SRAM), and non-volatile storage devices such as a hard disk drive (HDD), a solid state drive (SSD), and a flash memory. The memory 222 stores system programs, including an operating system (OS), control programs, including computer-readable codes, and various parameters for controlling the power conversion operation performed by the power converter 21. The processor 221 reads and deploys the system programs, the control programs, and the parameter for execution on the memory 222, thereby implementing various arithmetic processes. The arithmetic processes performed by the controller 22 may be implemented by an application specific integrated circuit (ASIC), a field programmable gate array (FPGA), etc.

Note that it is not essential that the controller 22 of the motor drive 2 and the main controller 4 are separately provided. The controller 22 may be configured to calculate the torque command Tr* and the angular acceleration command a* on its own.

### <Calculation of Angle Difference>

The following description assumes a situation where the standstill motor 3 is about to be started.

FIG. 3 is a diagram for illustrating a relationship between the coordinate axis and the magnetic pole location of the rotor 301 during the start of the motor 3. As shown in FIG. 3, the d axis extends from the rotation shaft C of the rotor 301 toward the north pole of the rotor 301. The d axis rotates anti-clockwise by an angular velocity ω of the rotor 301. The q axis is orthogonal to the d axis (i.e., extends in a direction which progresses by 90 degrees in the forward direction of the electrical angle from the d axis).

When the sensorless control of the motor 3 is performed, it is difficult for the controller 22 to accurately grasp the d axis and the q axis of the rotor 301. Therefore, a γ-δ rotating frame is used, instead of the d-q rotating frame defined by the d axis and the q axis. The γ-δ rotating frame is defined by a γ axis and a δ axis estimating the d axis and the q axis. The γ axis extends from the rotation shaft C toward the estimated north pole of the rotor 301. The δ axis is orthogonal to the γ axis (i.e., extends in a direction which progresses by 90 degrees in the forward direction of the electrical angle from the γ axis).

A d-axis current and a q-axis current in the γ-δ rotating frame will be described as Id and Iq, respectively. A d-axis current command and a q-axis current command that are required to develop a torque in response to the torque command Tr* in the motor 3 will be described as Id* and Iq*, respectively. The d-axis current Id is used to generate a magnetic field in the motor 3. The q-axis current Iq corresponds to the torque of the motor 3. The controller 22 sets the q-axis current command Iq* to zero and the d-axis current command Id* to a variable value to prevent the motor 3 from developing the torque and cause a magnetic field to be generated at a designated location. In the example of FIG. 3, the controller 22 causes generation of a magnetic field with a south polarity on the γ axis. This causes the rotor 301 to rotate so that the north pole of the rotor 301 is closer to the south pole (the generated magnetic field).

In the following, the angle difference of the γ axis from the d axis (the γ-δ rotating frame from the d-q rotating frame) will be described as an “angle difference Δθ.” The Δθ may be referred to as an “angular error,” instead of the angle difference. The d-axis voltage, the q-axis voltage, the y-axis voltage, and the δ-axis voltage will be described as Vd, Vq, Vγ, and Vδ, respectively. The winding resistance of the coil of the stator 302 will be described as R. The d-axis self-inductance and the q-axis self-inductance of the coils of the stator 302 will be described as Ld and Lq, respectively. A counter electromotive force constant of the motor 3 will be described as Ke [V/rpm].

In the d-q rotating frame, there are relationships indicated by Equations (1) and (2) below hold between the d-axis voltage Vd, the q-axis voltage Vq, the d-axis current Id, and the q-axis current Iq. Note that, for readability, the signs (d, q, γ, δ), etc. for distinguishing between the voltage/current axial directions are described using subscripts in the equations.

$${V}_{d} = {I}_{d} R - ω {L}_{q} {I}_{q} \qquad ( 1 )$$

$${V}_{q} = {I}_{q} R + ω {L}_{d} {I}_{d} + ω {K}_{e} \qquad ( 2 )$$

In the γ-δ rotating frame, in contrast, the y-axis voltage Vγ and the δ-axis voltage Vδ are represented by Equations (3) and (4):

$${V}_{γ} = {I}_{d} cos ( Δθ ) R - ω {LI}_{d} sin ( Δθ ) \qquad ( 3 )$$

$${V}_{δ} = {I}_{q} sin ( Δθ ) R + ω {LI}_{d} cos ( Δθ ) + ω {K}_{e} \qquad ( 4 )$$

where Ld=Lq=L is assumed.

Equations (3) and (4) can be represented in a matrix of Equation (5):

$$( \begin{matrix}{V}_{γ} \\ {V}_{δ}\end{matrix} ) = ( \begin{matrix}cos ( Δθ ) & - sin ( Δθ ) \\ sin ( Δθ ) & cos ( Δθ )\end{matrix} ) ( \begin{matrix}{I}_{d} R \\ ω {LI}_{d}\end{matrix} ) + ( \begin{matrix}0 \\ ω {K}_{e}\end{matrix} ) \qquad ( 5 )$$

The d-axis voltage Vd and the q-axis voltage Vq in the d-q rotating frame are obtained by rotating the y-axis voltage Vγ and the δ-axis voltage Vδ in the γ-δ rotating frame as represented by Equation (6):

$$( \begin{matrix}{V}_{d} \\ {V}_{q}\end{matrix} ) = ( \begin{matrix}cos ( Δθ ) & sin ( Δθ ) \\ - sin ( Δθ ) & cos ( Δθ )\end{matrix} ) ( \begin{matrix}{V}_{γ} \\ {V}_{δ}\end{matrix} ) \qquad ( 6 )$$

Rearranging Equation (6) by substituting the right side of Equation (6) with Equation (5) results in Equations (7) and (8):

$${V}_{d} - {I}_{d} R + ω {L}_{q} {I}_{q} = sin ( Δθ ) ω {K}_{e} \qquad ( 7 )$$

$${V}_{q} - {I}_{q} R - ω {LI}_{d} = cos ( Δθ ) ω {K}_{e} \qquad ( 8 )$$

Here, for the tangent (tan) of the angle difference Δθ, Equation (9) always holds true.

$$tan ( Δθ ) = \frac{sin ( Δθ ) ω {K}_{e}}{cos ( Δθ ) ω {K}_{e}} \qquad ( 9 )$$

Thus, based on Equations (7) to (9), the angle difference Δθ can be represented by Equation (10):

$$tan ( Δθ ) = \frac{{V}_{d} - {I}_{d} R + ω {L}_{q} {I}_{q}}{{V}_{q} - {I}_{q} R - ω {L}_{d} {I}_{d}} \qquad ( 10 )$$

Equation (10) may be represented by Equation (11):

$$Δ θ = {tan}^{- 1} ( \frac{{V}_{d} - {I}_{d} R + ω {L}_{q} {I}_{q}}{{V}_{q} - {I}_{q} R - ω {L}_{d} {I}_{d}} ) \qquad ( 11 )$$

The control according to the present embodiment may be performed on a tan(Δθ) basis as represented by Equation (10), or on an angle difference Δθ [deg] basis as represented by Equation (11). Hereinafter, for convenience, an example will be described in which the control is performed on the angle difference Δθ basis. However, a person skilled in the art can appropriately read it on the tan(Δθ) basis.

### <Time Diagram>

### Comparative Example

For ease of understanding of the control during the start of the motor according to the present embodiment, a control during the start of a motor according to Comparative Example will be initially described.

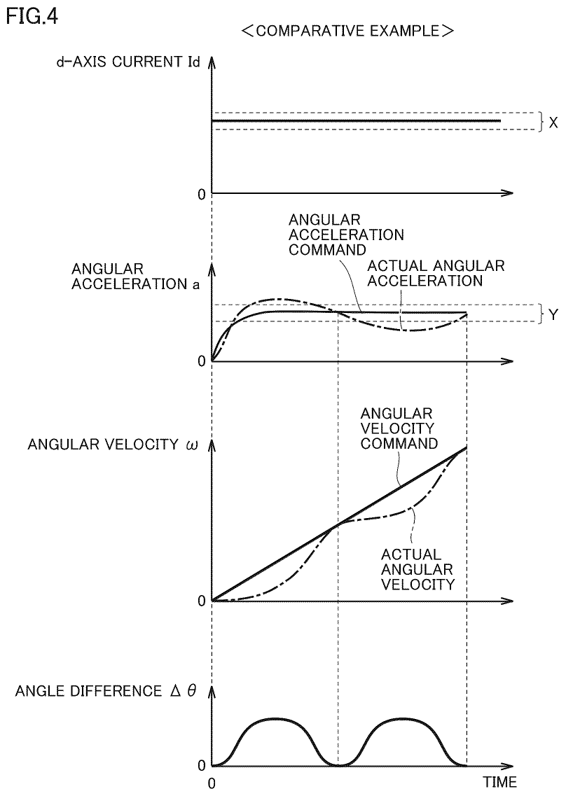

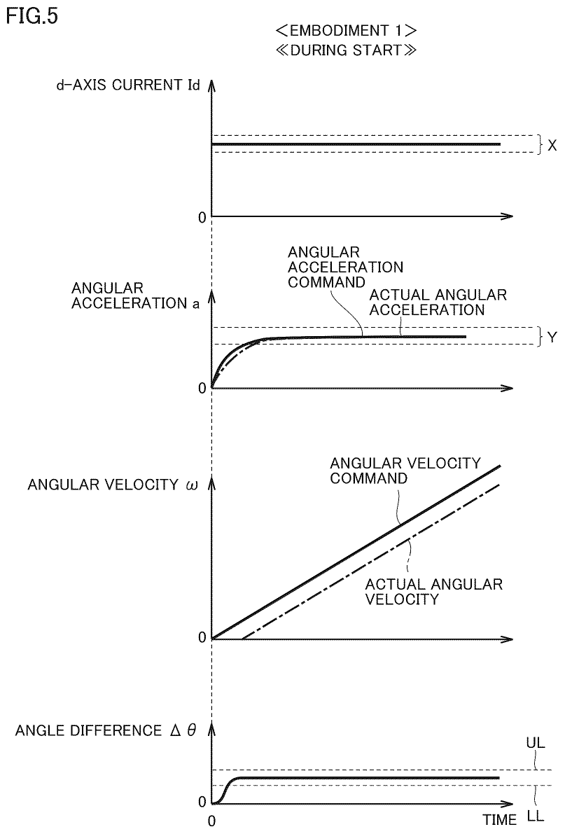

FIG. 4 is a time diagram illustrating changes over time in respective parameters upon start-up of the motor according to Comparative Example. The elapsed time is indicated on the horizontal axis. From top to bottom, a d-axis current Id [A], an angular acceleration a [rpm/s] of a rotor 301, an angular velocity ω [rpm] of the rotor 301, and an angle difference Δθ [deg] are indicated on the vertical axis. The same is true for FIG. 5 described later.

During the acceleration of the rotor, the d-axis current is controlled to be constant so as to remain within a certain range X. The angular acceleration command is also controlled to be constant so as to remain within a certain range Y. Therefore, an angular velocity command monotonically increases (in this example, increases at a constant rate) over time. If the angular acceleration command is set to be low in order to prevent the motor from losing steps, it can take a longer time for the motor to start. If the angular acceleration command is set to be high in order to reduce the time taken for the motor to start, in contrast, the rotation of the rotor may fail to follow the command, and the actual angular acceleration and the actual angular velocity may temporally fluctuate, as shown in FIG. 4. In that case, the angle difference Δθ repeatedly increases and decreases. As a result, the motor 3 is likely to lose steps, especially, when the angle difference Δθ increases.

### Present Embodiment

FIG. 5 is a time diagram illustrating changes over time in parameters upon start-up of the motor 3 according to Embodiment 1. This time diagram is compared to the time diagram according to Comparative Example illustrated in FIG. 4.

As shown in FIG. 5, in the present embodiment, in addition to the d-axis current being controlled to be constant so as to remain within a certain range X and the angular acceleration command being controlled to be constant so as to remain within a certain range Y (this causes the angular velocity command to monotonically increase over time), the angle difference Δθ is kept constant. The angle difference Δθ being “constant” includes, but not limited to, the angle difference Δθ as being kept strictly constant at a target value, and means the angle difference Δθ as being within a range encompassing the target value. In other words, the angle difference Δθ may fluctuate within a range defined by an upper limit UL and a lower limit LL in the figure. The angle difference Δθ being stabilized within that range makes the motor 3 less likely to lose steps. Accordingly, as compared to Comparative Example, the angular acceleration command can be set to a high value, thereby allowing reduction of the time taken for the motor 3 to start. Thus, according to the present embodiment, the motor 3 is allowed to start promptly, while being prevented from losing steps.

### <Functional Block>

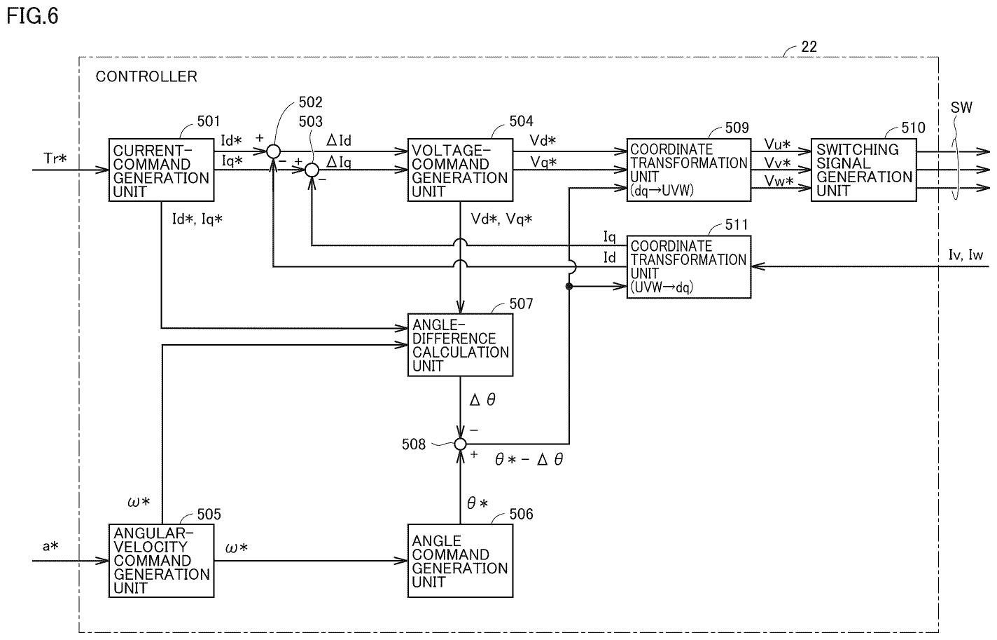

FIG. 6 is a functional block diagram of the controller 22 according to Embodiment 1. The controller 22 includes a current-command generation unit 501, subtracting units 502 and 503, a voltage-command generation unit 504, an angular-velocity command generation unit 505, an angle command generation unit 506, an angle-difference calculation unit 507, a subtracting unit 508, a coordinate transformation unit 509, a switching signal generation unit 510, and a coordinate transformation unit 511.

The current-command generation unit 501, in this example, receives the torque command Tr* from the main controller 4 (see FIG. 1). The current-command generation unit 501 generates, according to a prepared map, table, etc., the d-axis current command Id* and the q-axis current command Iq* for developing a torque in the motor 3 in response to the torque command Tr*. The current-command generation unit 501 outputs the d-axis current command Id* and the q-axis current command Iq* to the subtracting units 502 and 503, respectively. The current-command generation unit 501 also outputs the d-axis current command Id* and the q-axis current command Iq* to the angle-difference calculation unit 507.

The subtracting unit 502 calculates and outputs to the voltage-command generation unit 504 a d-axis current deviation ΔId (=Id−Id*), which is the deviation between the d-axis current Id from the coordinate transformation unit 511 and a d-axis current command value Idc from the current-command generation unit 501. The subtracting unit 503 calculates and outputs to the voltage-command generation unit 504 a q-axis current deviation ΔIq (=Iq−Iq*), which is the deviation between the q-axis current Iq from the coordinate transformation unit 511 and the q-axis current command Iq* from the current-command generation unit 501.

The voltage-command generation unit 504 performs a proportional integral (PI) computation of the d-axis current deviation ΔId from the subtracting unit 502, and outputs a result of the computation to the coordinate transformation unit 509 as a d-axis voltage command Vd*. Similarly, the voltage-command generation unit 504 performs the PI computation of the q-axis current deviation ΔIq from the subtracting unit 503, and outputs a result of the computation to the coordinate transformation unit 509 as a q-axis voltage command Vq*. In addition, the voltage-command generation unit 504 outputs the d-axis voltage command Vd* and the q-axis voltage command Vq* to the angle-difference calculation unit 507.

The angular-velocity command generation unit 505, in this example, receives the angular acceleration command a* from the main controller 4 (see FIG. 1). The angular-velocity command generation unit 505 performs a predetermined computation (e.g., the integral of the angular acceleration command a*) on the angular acceleration command a* to calculate the angular velocity command ω*. The angular-velocity command generation unit 505 outputs the angular velocity command ω* to the angle command generation unit 506 and the angle-difference calculation unit 507.

The angle command generation unit 506 performs a predetermined computation (e.g., the integral of the angular velocity command ω*) on the angular velocity command ω* from the angular-velocity command generation unit 505 to calculate an angle command θ*. The angle command generation unit 506 outputs the angle command θ* to the subtracting unit 508.

The angle-difference calculation unit 507 receives the d-axis current command Id* and the q-axis current command Iq* from the current-command generation unit 501, the d-axis voltage command Vd* and the q-axis voltage command Vq* from the voltage-command generation unit 504, and the angular velocity command ω* from the angular-velocity command generation unit 505. The angle-difference calculation unit 507 calculates the angle difference Δθ according to Equation (11), and outputs the angle difference Δθ to the subtracting unit 508.

The subtracting unit 508 calculates the difference (θ*−Δθ) between the angle command θ* from the angle command generation unit 506 and the angle difference Δθ from the angle-difference calculation unit 507. This process corresponds to correcting the angle command θ* by the angle difference Δδ. The subtracting unit 508 outputs this difference, stated differently, the corrected angle command (θ*−Δθ) to the coordinate transformation units 509 and 511.

According to a well-known coordinate transformation formula (a d-q two-phase to UVW three-phase transformation formula) using the corrected angle command (θ* −Δθ) from the subtracting unit 508, the coordinate transformation unit 509 transforms the d-axis voltage command Vd* and the q-axis voltage command Vq* on the d-q two-phase coordinates into a U-phase voltage command Vu*, a V-phase voltage command Vv*, and a W-phase voltage command Vw* on the UVW three-phase coordinates. The coordinate transformation unit 509 outputs the voltage commands Vu*, Vv*, and Vw* of the respective phases to the switching signal generation unit 510.

The switching signal generation unit 510 generates the switching signals SW from the voltage commands Vu*, Vv*, and Vw* of the respective phases. More specifically, the switching signal generation unit 510 generates PWM signals as the switching signals SW, based on comparing the voltage commands Vu*, Vv*, and Vw* with a predefined carrier wave. The switching signal generation unit 510 outputs the switching signals SW to the inverter 213 (see FIG. 2).

According to a well-known coordinate transformation formula (a UVW three-phase to d-q two-phase transformation formula) using the corrected angle command (θ*−Δθ) from the subtracting unit 508, the coordinate transformation unit 511 transforms the V-phase current Iv and the W-phase current Iw, respectively detected by the current sensors 31 and 32 (see FIG. 2), into the d-axis current Id and the q-axis current Iq. The coordinate transformation unit 511 outputs the d-axis current Id to the subtracting unit 502 and the q-axis current Iq to the subtracting unit 503.

As described above, in Embodiment 1, the correction of the angle command θ* (the corrected angle command (θ*−Δθ)) allows the angle difference Δθ to be kept constant. The angle difference Δθ being stabilized makes the motor 3 unlikely to lose steps. Accordingly, the angular acceleration a can be set to a higher value, without causing the motor 3 to lose steps, thereby allowing reduction of the time taken for the motor 3 to start. Thus, according to Embodiment 1, the motor 3 is allowed to start promptly, while being prevented from losing steps.

### [Variation]

In Embodiment 1, the control during the start of the motor 3 (during the acceleration of the rotor 301) has been described. In Variation, a control during a stop of the motor 3 (during deceleration of the rotor 301) will be described.

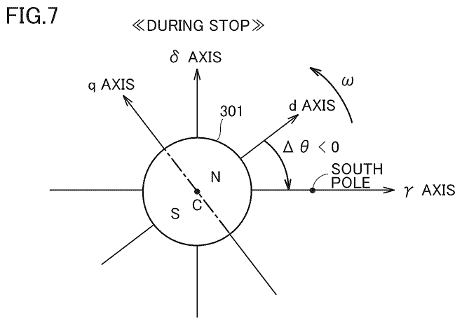

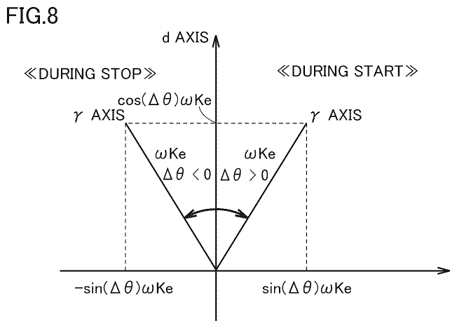

FIG. 7 is a diagram for illustrating a relationship between the coordinate axis and the magnetic pole location of the rotor 301 during a stop of the motor 3. This figure will be compared with FIG. 3 illustrating the relationship during the start of the motor 3. FIG. 8 is a schematic diagram for illustrating the angle difference Δθ during the start of the motor 3 and during the stop of the motor 3. As shown in FIGS. 7 and 8, during the stop of the motor 3, the angle difference Δθ is set in a direction opposite that during the start of the motor 3 (a direction opposite the angular velocity ω). While the angle difference Δθ during the start of the motor 3 is a positive value (Δθ>0), the angle difference Δθ during the stop of the motor 3 is a negative value (Δθ<0).

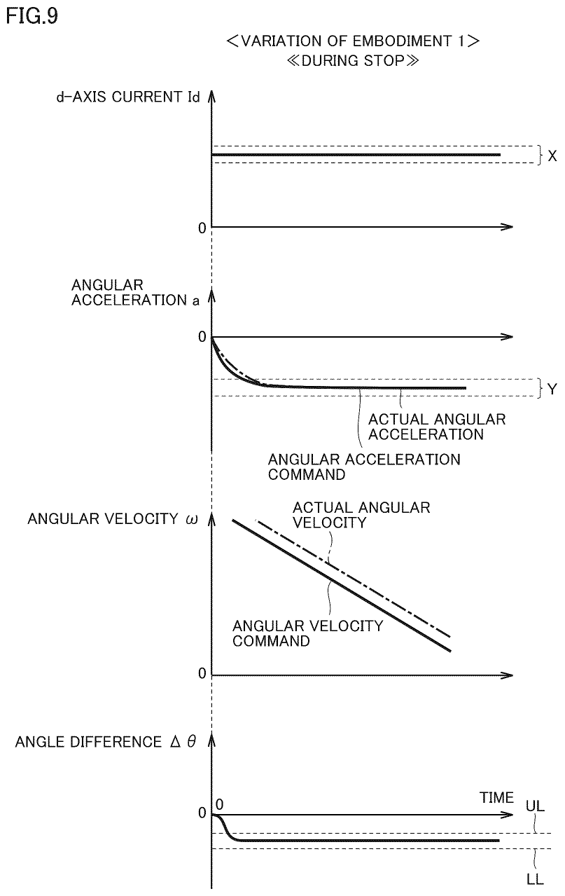

FIG. 9 is a time diagram illustrating changes over time in respective parameters during the stop of the motor 3. As shown in FIG. 9, the angle difference Δθ is kept constant at a negative value. Similarly to during the start of the motor 3, the angle difference Δθ may fluctuate within a range defined by an upper limit UL and a lower limit LL. The angle difference Δθ being stabilized within that range makes the motor 3 less likely to lose steps.

Note that a functional block diagram during the stop of the motor 3 is the same as the functional block diagram (see FIG. 6) during the start of the motor 3, and the description thereof will, thus, not be repeated.

As described above, in Variation of Embodiment 1, the angle difference Δθ, while it has a different sign, is kept constant, as with Embodiment 1. The angle difference Δθ being stabilized allows the angular acceleration a to be set to a higher value, without causing the motor 3 to lose steps. As a result, the time taken by the motor 3 to stop can be reduced. Thus, according to Variation of Embodiment 1, the motor 3 is allowed to stop promptly, while being prevented from losing steps. For example, if the motor 3 is adopting an air bearing, the wear of the shaft (journal) and the receiver (sleeve) can be minimized by the motor 3 stopping promptly.

### Embodiment 2

In Embodiment 2, a configuration will be described in which additional various controls are performed in response to an angle difference Δθ. For ease of understanding, the following description assumes such controls during the start of a motor 3. However, the same controls can be performed during the stop of the motor 3.

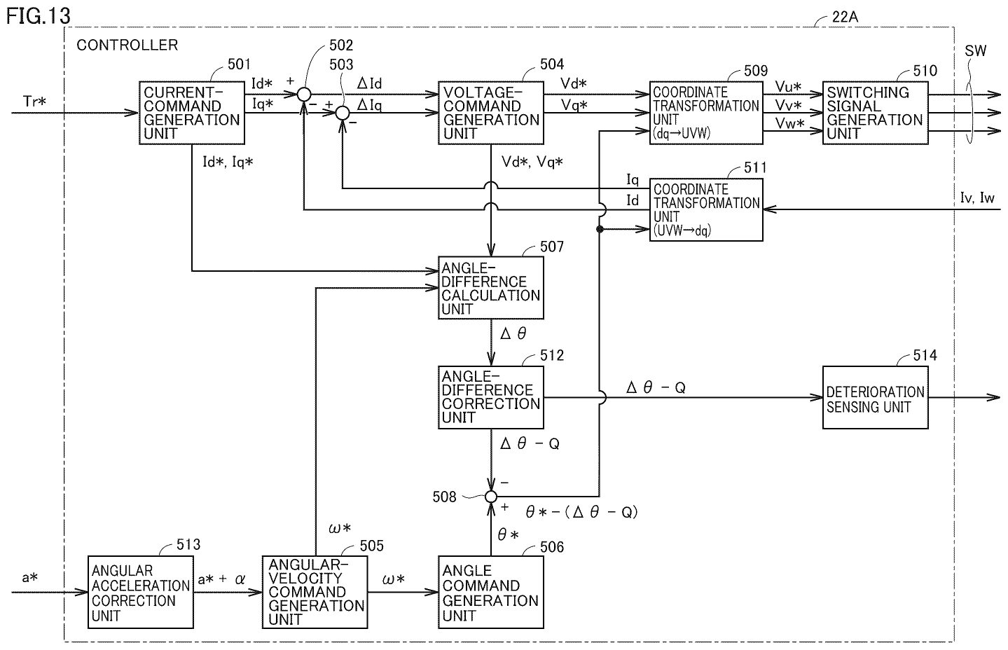

Note that a motor system according to Embodiment 2 has the same overall configuration as the overall configuration of the motor system 100 according to Embodiment 1 (see FIGS. 1 and 2), except that the motor drive 2 includes a controller 22A (see FIG. 13), instead of the controller 22, and the description thereof will, thus, not be repeated.

### <Execution Conditions>

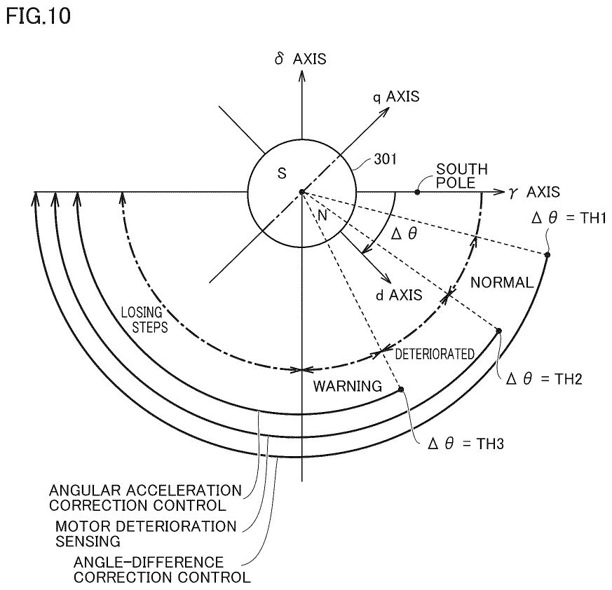

FIG. 10 is a schematic diagram for illustrating execution conditions for the various controls according to Embodiment 2. In Embodiment 2, three thresholds are set for the angle difference Δθ, as shown in FIG. 10. The three thresholds increase in the order of a first threshold TH1, a second threshold TH2, and a third threshold TH3. Note that the thresholds for the angles in the figure and specific values described later are by way of example, and the present disclosure is not limited thereto.

The controller 22A is configured to perform an angle-difference correction control, a motor deterioration sensing, and an angular acceleration correction control, depending on the magnitude relation between the three thresholds. More specifically, if the angle difference Δθ exceeds the first threshold TH1, the controller 22A performs the angle-difference correction control. If the angle difference Δθ exceeds the second threshold TH2, the controller 22A performs the motor deterioration sensing. If the angle difference Δθ exceeds the third threshold TH3, the controller 22A performs the angular acceleration correction control.

Note that the motor deterioration sensing is performed if the corrected angle difference caused by the angle-difference correction control exceeds the second threshold TH2, as will be described with respect to FIG. 13. The angular acceleration correction control is performed if the corrected angle difference caused by the angle-difference correction control exceeds the third threshold TH3. However, for simplification, instead of describing a corrected angle difference, the angle difference Δθ is simply described in FIGS. 10 to 12.

### <<Angle-Difference Correction Control>>

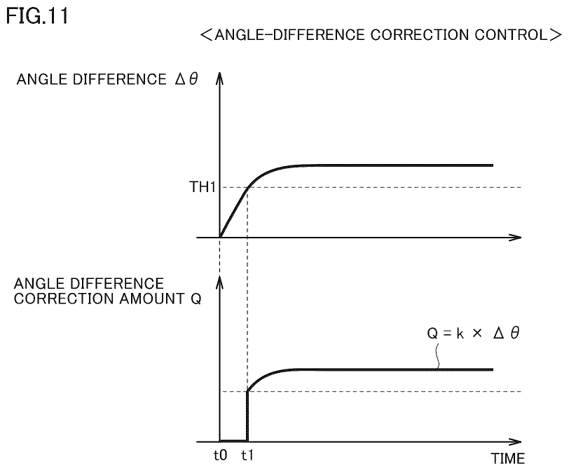

FIG. 11 is a time diagram for illustrating the angle-difference correction control. The elapsed time is indicated on the horizontal axis. The angle difference Δθ is indicated on the upper vertical axis, and an amount Q of angle difference correction is indicated on the lower vertical axis.

The angle-difference correction control is a control of reducing, if the angle difference Δθ exceeds the first threshold TH1, the angle difference Δθ by the correction amount Q, stated differently, a control of returning the d axis, excessively away from the γ axis, toward γ axis by the correction amount Q. The corrected angle difference is described as (Δθ−Q). The correction amount Q is zero or a positive value.

The angle difference Δθ during the start of the motor 3 (see time t0) is, typically, zero. After the start of the motor 3, the angle difference Δθ increases spontaneously with an increase in angular velocity ω. During this time period, there is no need to reduce the angle difference Δθ. Accordingly, if the angle difference Δθ is less than or equal to the first threshold TH1, the angle difference Δθ is not to be corrected, and the correction amount Q is set to zero.

The first threshold TH1 is pre-set, according to the specifications of the motor 3, to a value greater than a typical increase of the angle difference Δθ associated with an increase of the angular velocity ω. The first threshold TH1 is, for example, TH1=20 degrees.

The angle difference Δθ exceeding the first threshold TH1 means that the angle difference Δθ has increased beyond the typical increase. Therefore, as the angle difference Δθ exceeds the first threshold TH1 (see time t1), the angle difference Δθ is corrected and the correction amount Q is set to a non-zero value. Desirably, the greater the increase of the angle difference Δθ, a greater value the correction amount Q is set to. By way of example, the correction amount Q can be set to Q=k×θ, where k is a positive constant. Due to this, the greater the angle difference Δθ is, the greater the return amount of the angle difference Δθ, resulting in a reduction in corrected angle difference Δθ. Accordingly, an excessive increase of the angle difference Δθ can be inhibited.

### <<Motor Deterioration Sensing>>

If the motor 3 deteriorates, the angle difference Δθ can increase, as compared to the motor 3 without deterioration. More specifically, if the magnetic attraction of the permanent magnet of the rotor 301 deteriorates, the torque that is required for the rotor 301 to rotate increases and the d axis becomes harder to rotate. Consequently, the angle difference Δθ can increase. Moreover, if the winding resistance of the coils in the stator 302 increases, the magnetic field generated by the stator 302 is weakened, making the d axis harder to rotate. Consequently, the angle difference Δθ can increase.

The second threshold TH2 is predetermined based on, for example, a result of experiment comparing a deteriorated motor with a non-deteriorated motor. The second threshold TH2 is, for example, TH2=40 degrees.

If the angle difference Δθ is less than or equal to the second threshold TH2, the motor 3 is determined to be not deteriorated. If the angle difference Δθ exceeds the second threshold TH2, it is determined that deterioration of the motor 3 is sensed. If the deterioration of the motor 3 is sensed, desirably, such information is informed to a user or recorded.

### <<Angular Acceleration Correction Control>>

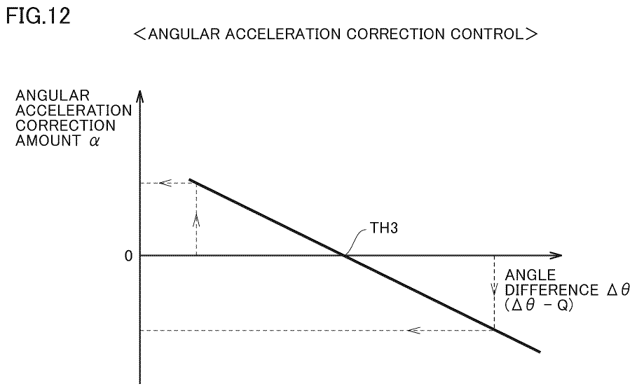

FIG. 12 is a diagram for illustrating an amount of angular acceleration correction by the angular acceleration correction control. The angle difference Δθ (more specifically, the corrected angle difference caused by the angle-difference correction control) is indicated on the horizontal axis. An amount α of angular acceleration correction by the angular acceleration correction control is indicated by the vertical axis.

If the angle difference Δθ further increases due to a further progression of the deterioration of the motor 3, the motor 3 is more likely to lose steps. The angular acceleration correction control adjusts the angular acceleration by the correction amount α so that the angle difference Δθ is closer to the third threshold TH3, in order to prevent the motor 3 from losing steps. The corrected angular acceleration is described as (a+α). The correction amount α is a negative value, zero, or a positive value.

The third threshold TH3 is pre-set, according to the specifications of the motor 3, to a limit for the angle difference Δθ at which the motor 3 can lose steps if the angle difference Δθ exceeds beyond that limit. The third threshold TH3 is, for example, TH3=60 degrees.

As shown in FIG. 12 by way of example, the amount α of angular acceleration correction is set so that the amount α of angular acceleration correction is zero when the angle difference Δθ is equal to the third threshold TH3, the amount α of angular acceleration correction is a negative value when the angle difference Δθ is greater than the third threshold TH3, and the amount α of angular acceleration correction is a positive value when the angle difference Δθ is less than the third threshold TH3. Desirably, the correction amount α is set so that the corrected angular acceleration does not decrease below a guarantee value (a minimum value required for the motor 3 to start within a predetermined period of time).

As the angle difference Δθ exceeds the third threshold TH3, the angular acceleration correction control is initiated. Since the correction amount α is a negative value when the angle difference Δθ exceeds the third threshold TH3, the angular acceleration after the correction (a+α) decreases lower than the angular acceleration before the correction. In contrast, since the correction amount α is a positive value when the angle difference Δθ is less than or equal to the third threshold TH3, the angular acceleration after the correction (a+α) increases greater than the angular acceleration before the correction. Due to this, the angle difference Δθ is brought closer to the third threshold TH3, inhibiting the angle difference Δθ from greatly exceeding the third threshold TH3. Accordingly, the motor 3 can be more reliably prevented from losing steps.

### <Functional Block>

FIG. 13 is a functional block diagram of the controller 22A according to Embodiment 2. The controller 22A is the same as the controller 22 (see FIG. 6) according to Embodiment 1, except for further including an angle-difference correction unit 512, an angular acceleration correction unit 513, and a deterioration sensing unit 514.

The angle-difference correction unit 512 receives the angle difference Δθ from the angle-difference calculation unit 507. The angle-difference correction unit 512 sets the correction amount Q to meet Q=0 until the angle difference Δθ exceeds the first threshold TH1, and sets the correction amount Q to meet Q=k×Δθ if the angle difference Δθ exceeds the first threshold TH1 (see FIG. 11). The angle-difference correction unit 512 outputs the corrected angle difference (Δθ−Q) to the subtracting unit 508 and the deterioration sensing unit 514.

The angular acceleration correction unit 513 receives the angular acceleration command a* from the main controller 4 (see FIG. 1), for example. As the angle difference Δθ exceeds the third threshold TH3, the angular acceleration correction unit 513 initiates the angular acceleration correction control and sets the amount α of angular acceleration correction in response to the angle difference Δθ (see FIG. 12). The angular acceleration correction unit 513 outputs the corrected angular acceleration command (a*+α) to the angular-velocity command generation unit 505.

The deterioration sensing unit 514 receives the corrected angle difference (Δθ−Q) from the angle-difference correction unit 512. If the corrected angle difference (Δθ−Q) is less than or equal to the second threshold TH2, the deterioration sensing unit 514 determines that the motor 3 is not deteriorated. If the angle difference Δθ exceeds the second threshold TH2, the deterioration sensing unit 514 determines that deterioration of the motor 3 is sensed. As the deterioration of the motor 3 is sensed, the deterioration sensing unit 514 externally informs or records such information. For example, if the motor system 100 is mounted on a vehicle, the deterioration sensing unit 514 may cause idiot light (not shown) to be turned on or record the deterioration sensing to a DIAG (a fault diagnosis function).

Functional blocks, other than the above, are the same as corresponding functional blocks according to Embodiment 1, and the description thereof will, thus, not be repeated.

In this manner, in Embodiment 2, the controller 22A performs the angle-difference correction control, the motor deterioration sensing, and the angular acceleration correction control. The angle-difference correction control can inhibit an excessive increase of the angle difference Δθ. The motor deterioration sensing enables a user to take appropriate countermeasures for the motor 3 such as requesting the administrator to repair or exchange the motor 3. The angular acceleration correction control can more reliably prevent the motor 3 from losing steps. However, the controller 22A do not have to perform all the above controls. The controller 22A may perform one of the three controls, or any one or two of the controls only.

### <Process Flow>

### <<Angle-Difference Correction Control>>

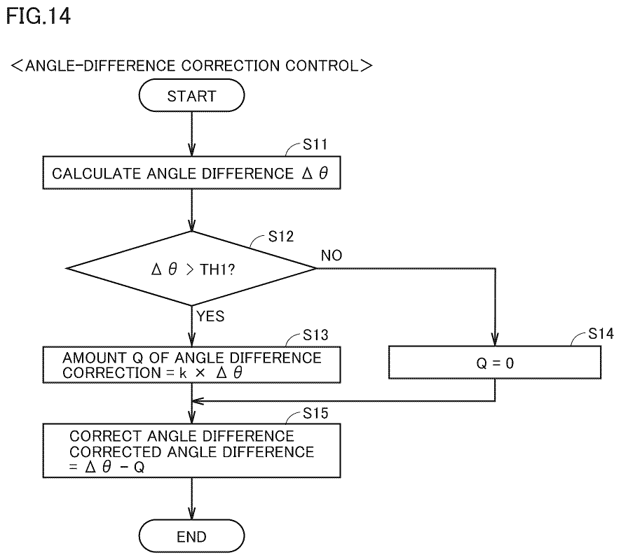

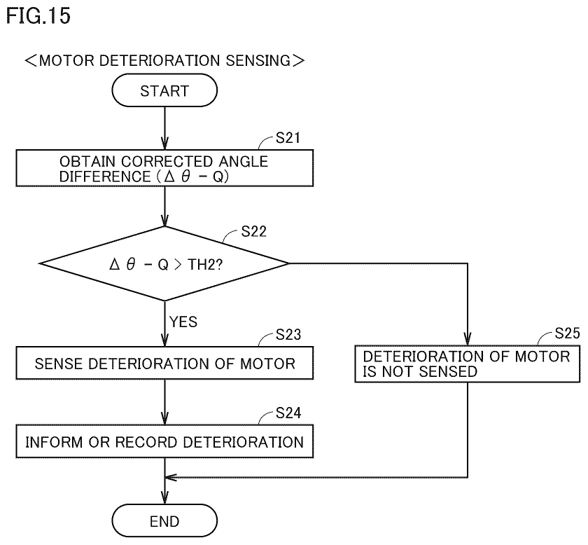

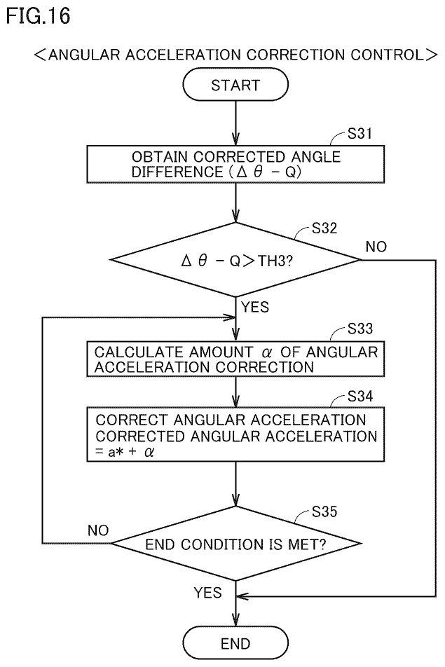

FIG. 14 is a flowchart illustrating a procedure for the angle-difference correction control. The process illustrated in this flowchart is performed when a specified condition is met (e.g., every predetermined cycle). Each process step is implemented by software processing by the controller 22A. However, each process step may be implemented by hardware (an electric circuit) disposed within the controller 22A. Hereinafter, a respective step will be abbreviated as S. The same is true for the flowcharts of FIGS. 15 and 16 described later.

In S11, the controller 22A calculates the angle difference Δθ according to the above Equation (11). Note that, as mentioned earlier, the controller 22A may perform the series of processes on the tangent basis, instead of the angle basis. In this case, the controller 22A calculates the angle difference tan(Δθ) according to Equation (10) above.

In S12, the controller 22A determines whether the angle difference Δθ is greater than the first threshold TH1. If the angle difference Δθ is greater than the first threshold TH1 (YES in S12), the controller 22A sets the amount Q of angle difference correction to meet Q=k×ΔQ (S13). If the angle difference Δθ is less than or equal to the first threshold TH1 (NO in S12), in contrast, the controller 22A sets the amount Q of angle difference correction to meet Q=0 (S14).

In S15, the controller 22A corrects the angle difference Δθ with the correction amount Q. This causes the motor 3 to start so that the corrected angle difference (Δθ−Q) is kept constant.

### <<Motor Deterioration Sensing>>

FIG. 15 is a flowchart illustrating a procedure for the motor deterioration sensing. In S21, the controller 22A obtains the angle difference (Δθ−Q) corrected by the angle-difference correction control.

In S22, the controller 22A determines whether the corrected angle difference (Δθ−Q) is greater than the second threshold TH2. If the corrected angle difference (Δθ−Q) is greater than the second threshold TH2 (YES in S22), the controller 22A determines that deterioration of the motor 3 is sensed (S23). Then, the controller 22A informs a user or records into the memory 222 that the deterioration of the motor 3 has been sensed (S24). If the corrected angle difference (Δθ−Q) is less than or equal to the second threshold TH2 (NO in S22), in contrast, the controller 22A determines that deterioration of the motor 3 is not sensed (S25).

### <<Angular Acceleration Correction Control>>

FIG. 16 is a flowchart illustrating a procedure for the angular acceleration correction control. In 531, the controller 22A obtains the corrected angle difference (Δθ−Q) by the angle-difference correction control.

In S32, the controller 22A determines whether the corrected angle difference (Δθ−Q) is greater than the third threshold TH3. If the corrected angle difference (Δθ−Q) is greater than the third threshold TH3 (YES in S32), the controller 22A passes the process to S33 where the controller 22A calculates the amount α of angular acceleration correction in response to the corrected angle difference (Δθ−Q) (see FIG. 12).

In S34, the controller 22A corrects the angular acceleration a with the correction amount α. This causes the motor 3 to start so that the angle difference corrected (Δθ−Q) by the angle-difference correction control is closer to the third threshold TH3.

In S35, the controller 22A determines whether an end condition for ending the correction of the angle difference has met. For example, the end condition is met if the start of the motor 3 has completed (the motor 3 has entered the steady-state drive). If the end condition is not met (NO in S35), the controller 22A passes the process to S33 to continue to correct the angle difference. If the end condition is met (YES in S35), the controller 22A ends the series of processes to end the correction of the angle difference.

Note that if the corrected angle difference (Δθ−Q) is less than or equal to the third threshold TH3 (NO in S32), S33 through S35 are skipped, without initiating the correction of the angular acceleration.

As described above, according to Embodiment 2, the angle difference Δθ is kept constant during the start of the motor 3, as with Embodiment 1. This allows the motor 3 to start promptly, while being prevented from losing steps. In addition, in Embodiment 2, the angle-difference correction control, the motor deterioration sensing, and the angular acceleration correction control are performed. The angle-difference correction control can inhibit an excessive increase of the angle difference Δθ. The motor deterioration sensing enables a user to take appropriate countermeasures for the deteriorated motor 3. The angular acceleration correction control can more reliably prevent the motor 3 from losing steps.

### <Appended Note>

Last, aspects of the present disclosure are collectively described as appended notes below:

### <<Appended Note 1>>

A motor drive, comprising:
a power converter that drives a motor including a rotor and a stator, the rotor having a permanent magnet, the stator having a coil wound around the stator; and
a controller that performs a sensorless control of the motor using the power converter, wherein
the controller creates an angle difference, between a d axis in a d-q rotating frame and a γ axis estimating the d axis, to cause the rotor to accelerate to start the motor, and
the controller controls the power converter so that, during acceleration of the rotor, a d-axis current remains within a certain range, an angular velocity of the rotor monotonically increases, and the angle difference is kept within a given range not including zero.

### <<Appended Note 2>>

The motor drive according to Appended Note 1, wherein
the controller controls the power converter so that the d-axis current is constant, the angular velocity increases at a constant rate, and the angle difference is kept constant.

### <<Appended Note 3>>

The motor drive according to Appended Note 1 or 2, wherein
the controller controls the angle difference according to Equation (10) or Equation (11) above:
where Δθ represents the angle difference,
Vd represents a d-axis voltage,
Vq represents a q-axis voltage,
Id represents the d-axis current,
Iq represents a q-axis current,
R represents a winding resistance of the coil,
ω represents the angular velocity,
Ld represents a d-axis self-inductance of the coil, and
Lq represents a q-axis self-inductance of the coil.

### <<Appended Note 4>>

The motor drive according to any one of Appended Notes 1 to 3, wherein
when the angle difference exceeds a first threshold during the acceleration of the motor, the controller reduces the angle difference as compared to when the angle difference is below the first threshold.

### <<Appended Note 5>>

The motor drive according to Appended Note 4, wherein
when the angle difference is below the first threshold, the controller does not reduce the angle difference.

### <<Appended Note 6>>

The motor drive according to Appended Note 4 or 5, wherein
when the angle difference exceeds the first threshold, the controller increases an amount of reduction of the angle difference as the angle difference increases.

### <<Appended Note 7>>

The motor drive according to any one of Appended Notes 1 to 6, wherein
when the angle difference exceeds a second threshold during the acceleration of the motor, the controller senses deterioration of the motor.

### <<Appended Note 8>>

The motor drive according to Appended Note 7, wherein
when the controller senses the deterioration of the motor, the controller notifies an outside of the motor drive of the deterioration of the motor.

### <<Appended Note 9>>

The motor drive according to Appended Note 7 or 8, wherein
when the controller senses the deterioration of the motor, the controller records the deterioration of the motor to a memory.

### <<Appended Note 10>>

The motor drive according to any one of Appended Notes 1 to 9, wherein
the controller calculates the angle difference based on an angular acceleration of the motor, and
when the angle difference exceeds a third threshold during the acceleration of the motor, the controller performs an angular acceleration correction control for correcting the angular acceleration so that the angle difference is closer to the third threshold.

### <<Appended Note 11

The motor drive according to Appended Note 10, wherein
during performance of the angular acceleration correction control, the controller corrects the angular acceleration so that the angular acceleration decreases when the angle difference is greater than the third threshold and the angular acceleration increases when the angle difference is less than the third threshold.

### <<Appended Note 12>>

A motor drive, comprising:
a power converter that drives a motor which includes a rotor and a stator, the rotor having a permanent magnet, the stator having a coil wound around the stator; and
a controller that performs a sensorless control of the motor using the power converter, wherein
the controller creates an angle difference, between a d axis in a d-q rotating frame and a γ axis estimating the d axis, to cause the rotor to decelerate to stop the motor, and
the controller controls the power converter so that, during deceleration of the rotor, a d-axis current remains within a certain range, an angular velocity of the rotor monotonically decreases, and the angle difference is kept within a given range not including zero.

### <<Appended Note 13>>

A motor system, comprising:
the motor drive according to any one of Appended Notes 1 to 12; and
the motor.

### <<Appended Note 14>>

A method of driving a motor including a rotor and a stator, the rotor having a permanent magnet, the stator having a coil wound around the stator, the method comprising:
creating an angle difference, between a d axis in a d-q rotating frame and a 7 axis estimating the d axis, to cause the rotor to accelerate to start the motor, and
the starting includes causing a d-axis current to remain within a certain range, causing an angular velocity of the rotor to monotonically increase, and keeping the angle difference within a given range not including zero.

While the embodiment according to the present disclosure has been described above, the embodiment presently disclosed should be considered in all aspects illustrative and not restrictive. The scope of the present disclosure is defined by the appended claims. All changes which come within the meaning and range of equivalency of the appended claims are to be embraced within their scope.

What is claimed is:

1. A motor drive, comprising:
a power converter that drives a motor including a rotor and a stator, the rotor having a permanent magnet, the stator having a coil wound around the stator; and
a controller that performs a sensorless control of the motor using the power converter, wherein
the controller creates an angle difference, between a d axis in a d-q rotating frame and a γ axis estimating the d axis, to accelerate the rotor to start the motor,
the controller controls the power converter so that, during acceleration of the rotor, a d-axis current remains within a certain range, an angular velocity of the rotor monotonically increases, and the angle difference is kept within a given range not including zero.

2. The motor drive according to claim 1, wherein
the controller controls the power converter so that the d-axis current is constant, the angular velocity increases at a constant rate, and the angle difference is kept constant.

3. The motor drive according to claim 1, wherein
the controller controls the angle difference according to Equation (1):
$$tan ( Δθ ) = \frac{{V}_{d} - {I}_{a} R + ω {L}_{q} {I}_{q}}{{V}_{q} - {I}_{q} R - ω {L}_{d} {I}_{d}} \qquad ( 1 )$$
where Δθ represents the angle difference,
Vd represents a d-axis voltage,
Vq represents a q-axis voltage,
Id represents the d-axis current,
Iq represents a q-axis current,
R represents a winding resistance of the coil,
ω represents the angular velocity,
Ld represents a d-axis self-inductance of the coil, and
Lq represents a q-axis self-inductance of the coil.

4. The motor drive according to claim 1, wherein
when the angle difference exceeds a first threshold during the acceleration of the motor, the controller reduces the angle difference as compared to when the angle difference is below the first threshold.

5. The motor drive according to claim 4, wherein
when the angle difference is below the first threshold, the controller does not reduce the angle difference.

6. The motor drive according to claim 4, wherein
when the angle difference exceeds the first threshold, the controller increases an amount of reduction of the angle difference as the angle difference increases.

7. The motor drive according to claim 1, wherein
when the angle difference exceeds a second threshold during the acceleration of the motor, the controller senses deterioration of the motor.

8. The motor drive according to claim 7, wherein
when the controller senses the deterioration of the motor, the controller notifies an outside of the motor drive of the deterioration of the motor.

9. The motor drive according to claim 7, wherein
when the controller senses the deterioration of the motor, the controller records the deterioration of the motor to a memory.

10. The motor drive according to claim 1, wherein
the controller calculates the angle difference based on an angular acceleration of the motor, and
when the angle difference exceeds a third threshold during the acceleration of the motor, the controller performs an angular acceleration correction control for correcting the angular acceleration so that the angle difference is closer to the third threshold.

11. The motor drive according to claim 10, wherein
during performance of the angular acceleration correction control, the controller corrects the angular acceleration so that the angular acceleration decreases when the angle difference is greater than the third threshold and the angular acceleration increases when the angle difference is less than the third threshold.

12. A motor drive, comprising:
a power converter that drives a motor including a rotor and a stator, the rotor having a permanent magnet, the stator having a coil wound around the stator; and
a controller that performs a sensorless control of the motor using the power converter, wherein
the controller creates an angle difference, between a d axis in a d-q rotating frame and a γ axis estimating the d axis, to decelerate the rotor to stop the motor,
the controller controls the power converter so that, during deceleration of the rotor, a d-axis current remains within a certain range, an angular velocity of the rotor monotonically decreases, and the angle difference is kept within a given range not including zero.

13. A motor system, comprising:
the motor drive according to claim 1; and
the motor.

14. A motor system, comprising:
the motor drive according to claim 12; and
the motor.

15. A method of driving a motor including a rotor and a stator, the rotor having a permanent magnet, the stator having a coil wound around the stator, the method comprising
creating an angle difference, between a d axis in a d-q rotating frame and a γ axis estimating the d axis, to accelerate the rotor to start the motor,
characterized in that
the starting includes causing a d-axis current to remain within a certain range, causing an angular velocity of the rotor to monotonically increase, and keeping the angle difference within a given range not including zero.
